(19) United States
(12) Patent Application Publication
(10) Pub. No.: US 2015/0176273 A1
(43) Pub. Date: Jun. 25, 2015

(54) ROOM DIVIDER

(71) Applicant: MOBICA LTD., Mohandessin (EG)

(72) Inventor: Mohammed Farouk, Mohandessin (EG)

(21) Appl. No.: 14/415,207

(22) PCT Filed: Jul. 19, 2013
(86) PCT No.: PCT/DE2013/100270

§ 371 Date: Feb. 13, 2015

(30) Foreign Application Priority Data
Jul. 19, 2012 (DE) 20 2012 102 705.4

(51) Int. Cl. E04B 2/74; B62B 3/02

(52) U.S. Cl. CPC E04B 2/7442; B62B 3/02

(57) ABSTRACT

The invention relates to a room divider (1, 101), having—a base frame (2) with crossbeams (3) and longitudinal beams (4), wherein the longitudinal beams (4) each have a profile element (9) provided with an elongated groove; at least one flap (5, 6), which spans the base frame (2) parallel to the crossbeams (3) and which is pivoted around a swivel axis;—at least one support arm (7, 8), which is movably connected to a first end region in the elongated groove of the profile element (9) of the longitudinal beam and to a second end region by the flap (5, 6); and—at least one fixed trim element (11, 12, 13), which spans the base frame (2) in a region which cannot be closed by the flap (5, 6).

The invention relates to a room divider.

Room dividers serve for individually and flexibly dividing large rooms. For example, room dividers are used in offices, in particular in open-plan offices, for delimiting the respective office workspaces from one another. It is possible in this way to obtain a sight and noise barrier and/or a screening from similar environmental influences (for example light effects, draft).

The object on which the invention is based is to provide a multifunctional room divider which can be used variably.

This object is achieved by a room divider having the features of claim 1. Advantageous embodiments are described in the dependent claims.

The room divider according to the invention has a base frame with crossmembers and longitudinal members, at least one flap, at least one support arm and at least one fixed screen element. The longitudinal members in each case have a profile element provided with a longitudinal groove. The flap spans the base frame parallel to the crossmembers and is pivotably mounted about a pivot axis. The support arm is connected by a first end region so as to be displaceable in the longitudinal groove of the profile element of the longitudinal member and is connected by a second end region to the flap. The fixed screen element spans the base frame in a region which cannot be closed by the flap.

The pivotable flap makes it possible for subregions of the room divider to be opened and in this way for further elements which are arranged within the room divider to be made accessible. The functionality of the room divider is increased as a result. The support arm ensures that the flap is mounted stably and allows simple pivoting of the flap between the opened and the closed position.

In one advantageous embodiment, the room divider also has rollers on which it can move. Consequently, the mobility of the room divider is increased and it can be transported rapidly and in an uncomplicated manner between various use locations.

In a further advantageous embodiment, the room divider has a lighting element. In a particularly advantageous manner, the lighting element is arranged here in such a way that it spans the base frame parallel to the crossmembers. If the lighting element is also mounted above the flap, a particularly advantageous illumination of the flap can thus be produced, thereby increasing the use possibilities and working comfort.

In a preferred embodiment, the flap is designed as an office work surface. As a result, the room divider additionally assumes the function of a fully adequate office workspace. The multifunctionality of the room divider is thus further increased. If the flap is folded out, it can thus serve, for example, as a writing surface or as a computer desk. When the workspace is not being used, the flap can be closed and the room divider can be stowed in a space-saving manner.

If a plurality of flaps are present, one flap can thus be designed as an office work surface and a further flap arranged further above can serve as a shelf, for example for depositing books and/or office files. In one such embodiment, the flap serving as an office work surface preferably has a greater width than the flap serving as a shelf.

In a further preferred embodiment, the room divider also has a storage compartment and/or board element arranged transversely with respect to the crossmembers and within the spatial volume defined by the base frame. The board element can be formed in particular as a magnetic board or pinboard. The storage compartment can be equipped for example with storage trays. The multifunctionality is additionally increased by the provision of the aforementioned additional elements.

In a further advantageous embodiment, the room divider also has a connection console with a plurality of connection facilities for producing a connection to electrical and/or communication lines. An integrated extension cable is also present in a preferred manner. In this way, a plurality of electrical and communication connection possibilities (for example LAN, telephone, . . . ) are available on the room divider.

In a further advantageous embodiment, the room divider has on the rear side at least one rear-side flap which is designed to be congruent to and the same size as a flap on the front side, and a rear-side support arm which is connected by a first end region so as to be displaceable in a rear-side longitudinal groove of the longitudinal member and which is connected by a second end region to the rear-side flap. The room divider according to this advantageous embodiment thus has at least one flap both on the front side and on the rear side. As a result, the room divider can be used on both sides. In addition, by arranging the flaps to be congruent and to have the same size, interaction between the user on the front side and the user on the rear side of the room divider is made possible: when the flaps are opened, visual contact can be established, for example.

The invention is explained further with reference to exemplary embodiments in the figures of the drawing, in which, in each case schematically,

FIG. 1 shows a perspective view of a first embodiment with opened flaps;

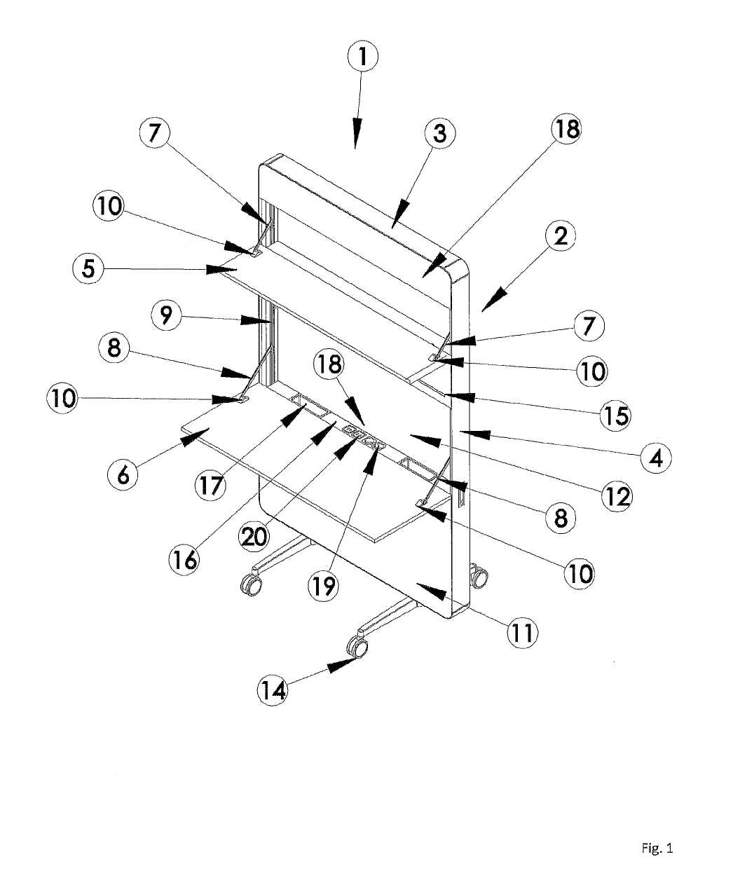

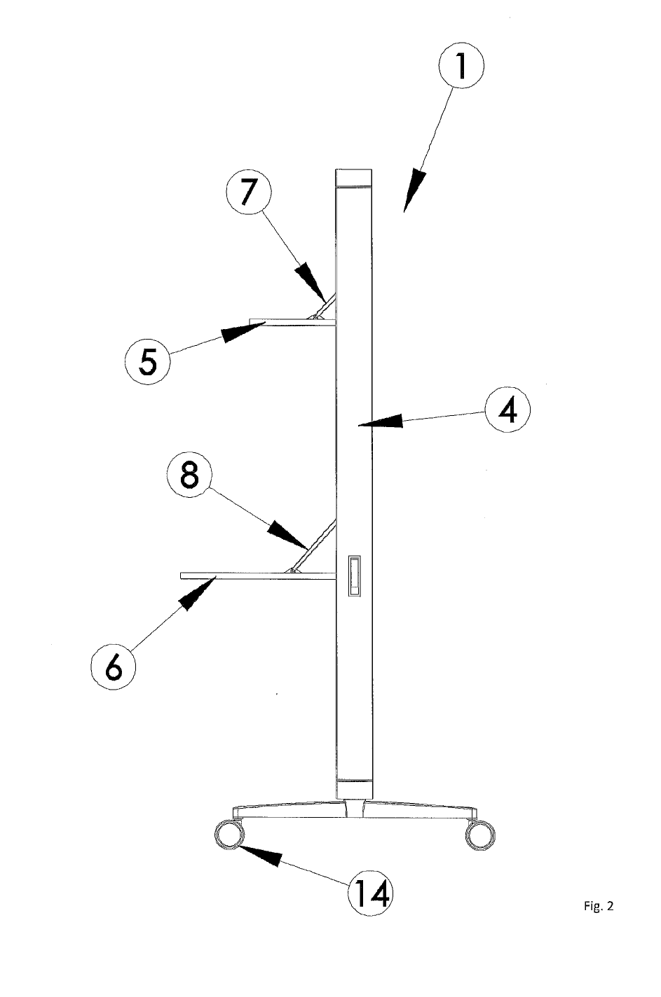

FIG. 2 shows a side view of the room divider from FIG. 1;

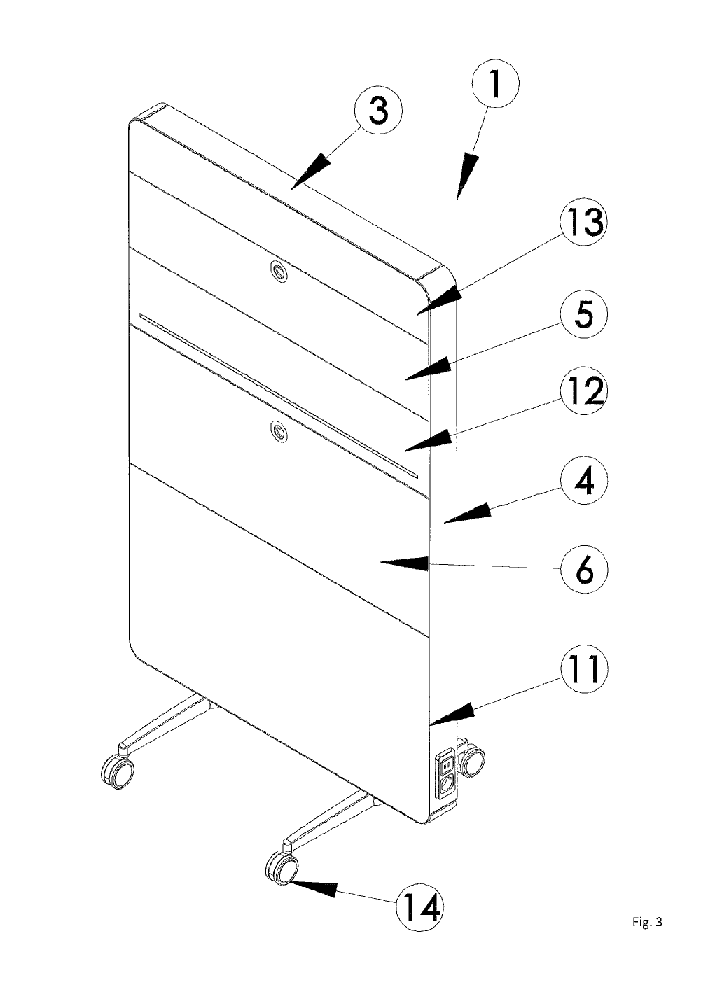

FIG. 3 shows a perspective view of the room divider with closed flaps;

FIG. 4 shows a side view of the room divider from FIG. 3;

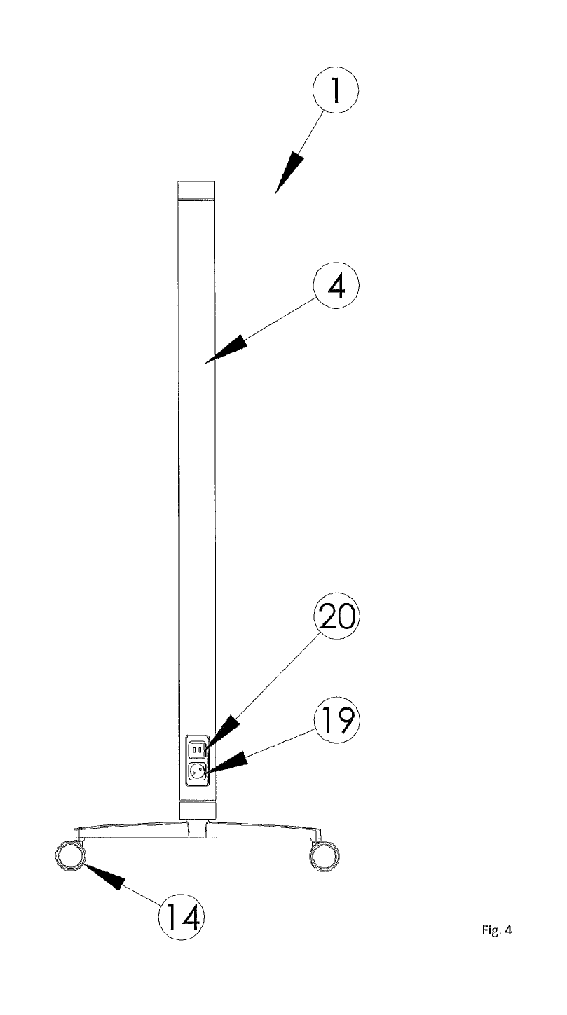

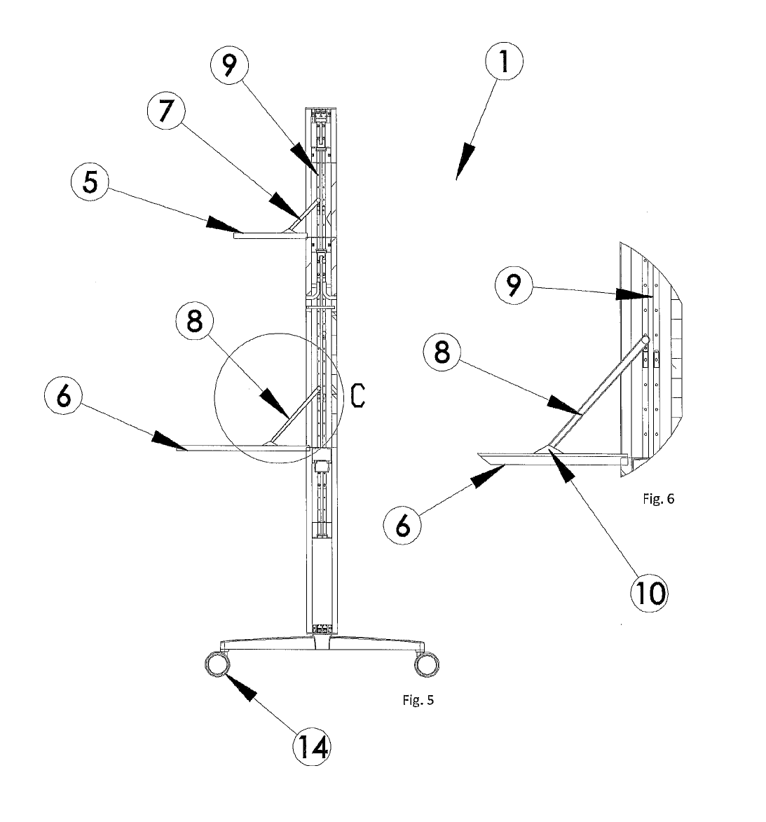

FIG. 5 shows a sectional view of the room divider from FIG. 1;

FIG. 6 shows an enlarged detail of the region C of FIG. 5;

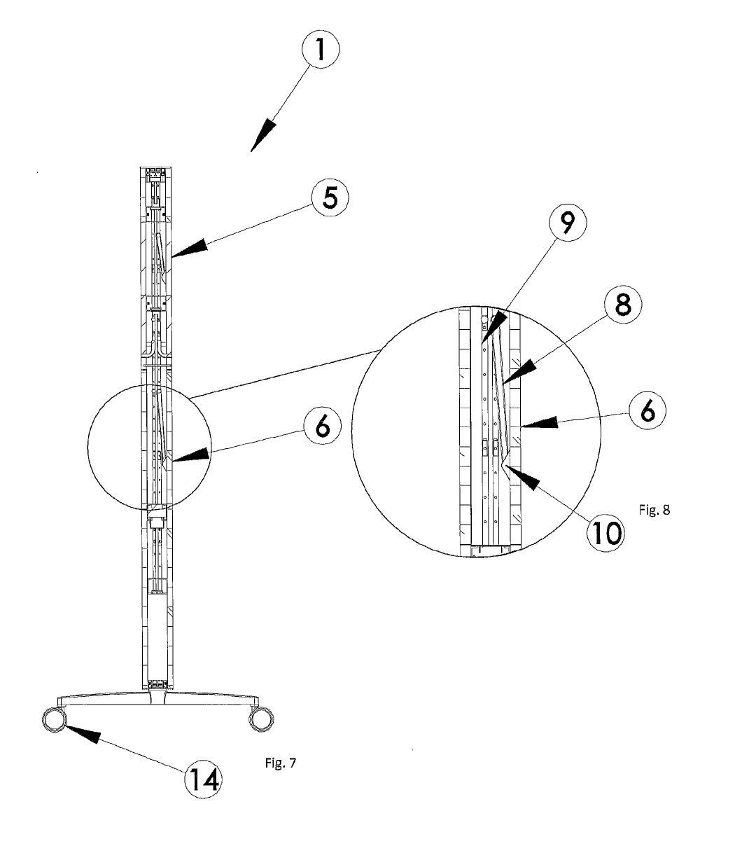

FIG. 7 shows a sectional view of the room divider from FIG. 3;

FIG. 8 shows an enlarged detail of the region B of FIG. 7;

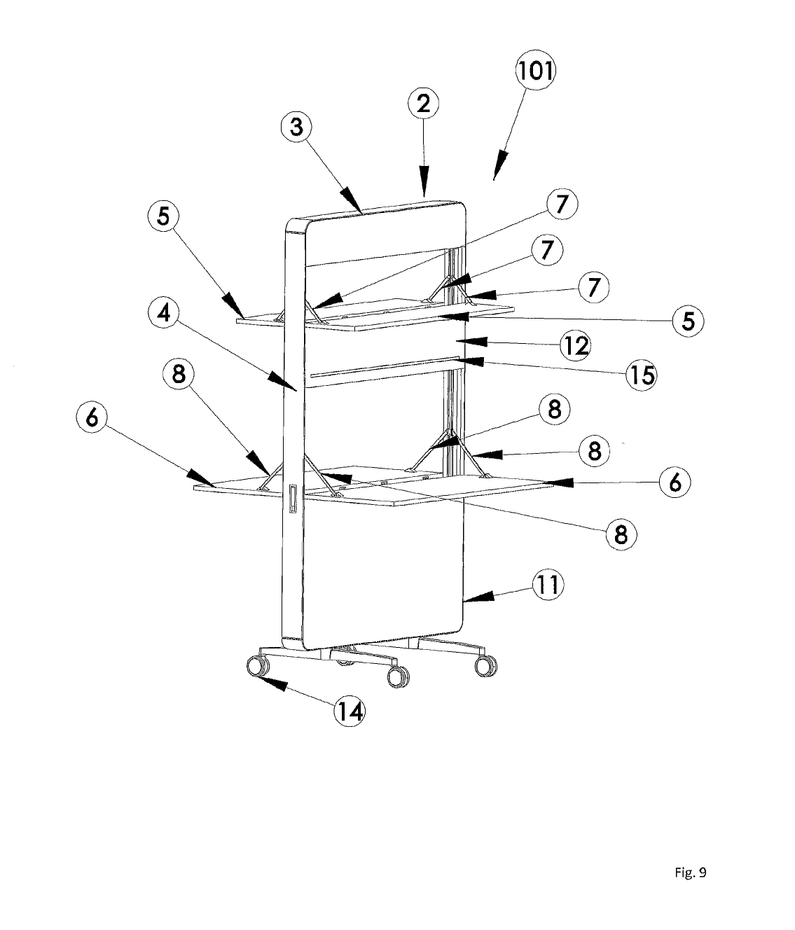

FIG. 9 shows a perspective view of a second embodiment with opened flaps;

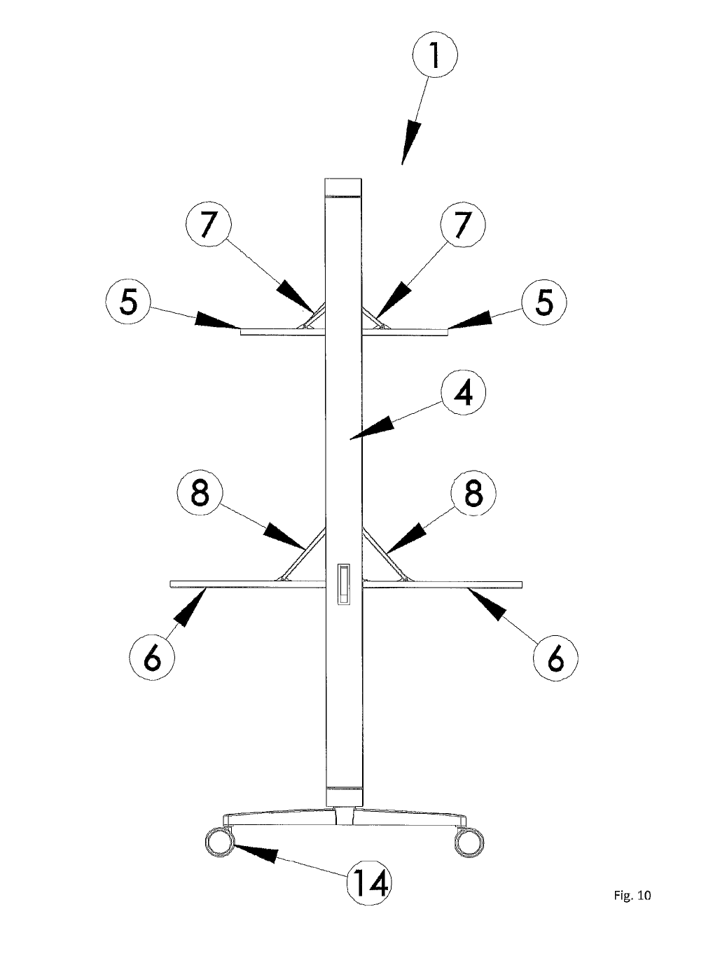

FIG. 10 shows a side view of the room divider from FIG. 9;

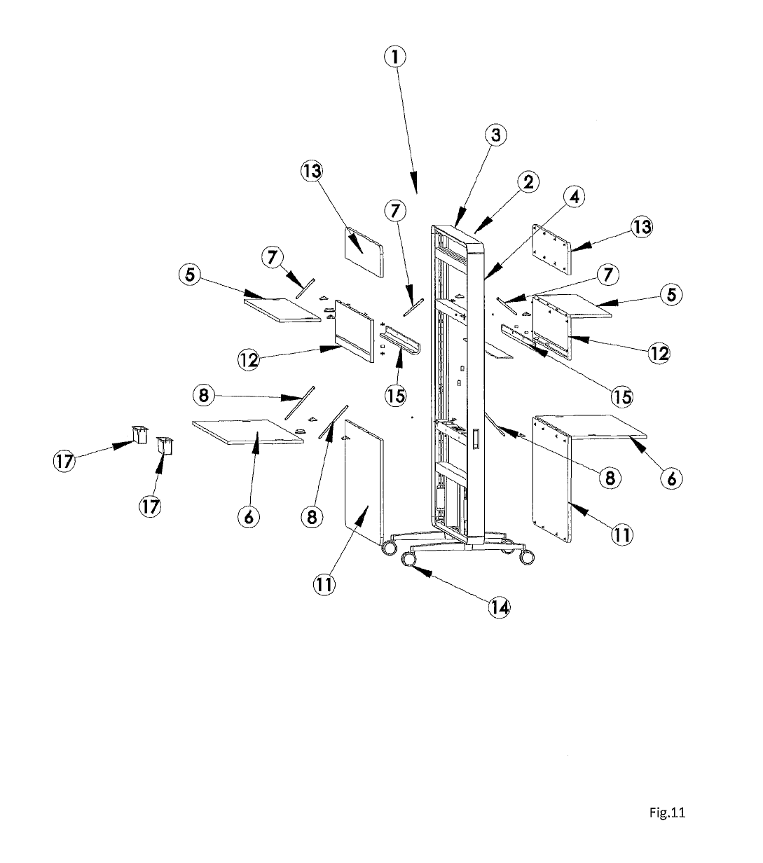

FIG. 11 shows an exploded illustration of the room divider from FIG. 9; and

FIG. 12 shows a plurality of room dividers in a storage position.

Identical or equivalent parts are provided with the same reference signs in the individual figures of the drawing.

FIG. 1 to FIG. 8 show a first embodiment. The room divider 1 has a base frame 2. The base frame 2 comprises crossmembers 3 and longitudinal members 4. The room divider 1 also has two flaps 5 and 6. The flaps 5, 6 span the base frame 2 parallel to the crossmembers 3 and are in each case rotatably mounted about a pivot axis. Each of the flaps 5, 6 is supported by two respective support arms 7, 8. Both flaps 5, 6 are situated on the front side of the room divider 1. The flap 5 has a smaller width than the flap 6 and is arranged above the flap 6. The flap 5 is designed as a shelf and the flap 5 is designed as an office work surface.

A first end region of the support arms 7, 8 is in each case mounted so as to be displaceable in a profile element 9 of the longitudinal member 4 that is provided with a longitudinal groove. The second end region of the support arms 7, 8 is connected to the flap 5 or 6 by a connection device 10.

The flaps 5, 6 are in each case pivotable about their pivot axis. Here, the support arms move within the longitudinal groove of the profile element 9 and the respective flap 5, 6 is brought either into a closed or an opened position. FIG. 1, FIG. 2, FIG. 5 and FIG. 6 show the room divider 1 with opened flaps 5, 6 and FIG. 3, FIG. 4, FIG. 7 and FIG. 8 show the room divider 1 with closed flaps 5, 6. The ability of the support arms 7, 8 to move in the longitudinal groove of the profile element 9 can be seen in particular from the enlarged illustration of FIG. 6 and FIG. 8.

The fixed screen elements 11, 12 and 13 span the base frame 2 in regions which cannot be closed by the flaps 5, 6. The base frame 2 is mounted on rollers 14 such that the room divider 1 is movable.

A lighting element 15 spans the base frame 2 parallel to the crossmembers 3 and is positioned between the flap 5 and the flap 6.

In the region of the pivot axis of the flap 6, a storage compartment 16 spans the base frame 2 parallel to the crossmembers 3. The storage compartment 16 is equipped with two storage trays 17 and a connection console 18. The connection console 18 has two plug sockets 19 and two mains sockets 20. A further plug socket 19 and a further mains socket 20 are fitted on the side of the base frame 2 (FIG. 4).

FIG. 9 to FIG. 11 show a second embodiment. The room divider 101 shown therein differs from the room divider 1 of the preceding embodiment in particular in that the room divider 101 has, both on the front side and on the rear side, two respective flaps which are designed to be congruent to and the same size as one another.

The room divider 101 has a base frame 2. The base frame 2 comprises crossmembers 3 and longitudinal members 4. Furthermore, the room divider 101 has in total four flaps, namely two flaps 5 and two flaps 6. The flaps 5, 6 span the base frame 2 parallel to the crossmembers 3 and are in each case rotatably mounted about a pivot axis. Each of the flaps 5, 6 is supported by two respective support arms 7, 8. A flap 5 and a flap 6 are in each case situated on the front side and the rear side of the room divider 101. The flaps 5 have a smaller width than the flaps 6 and are in each case arranged above the flaps 6. The flaps 5 are designed as shelves and the flaps 5 are designed as office work surfaces.

The two flaps 5 and the two flaps 6 are in each case designed to be congruent to and the same size as one another, with in each case one flap 5, 6 being arranged on the rear side and the other flap 5 or 6 being arranged on the front side.

The profile element 9 of the longitudinal member 4 has in total two longitudinal grooves arranged parallel to one another. The support arms 7, 8 assigned to the flaps 5, 6 of the front side are mounted so as to be displaceable in the first longitudinal groove and the support arms 7, 8 assigned to the flaps 5, 6 of the rear side are mounted so as to be displaceable in the second longitudinal groove.

FIG. 12 shows a plurality of room dividers 1 in a storage position. Each of the room dividers 1 illustrated in FIG. 12 has a base frame 2. Mounted thereon are the flaps 5, 6, the screen elements 11, 12, 13 and also the rollers 14 and the lighting element 15. The chassis of each room divider, which in particular comprises the rollers 14 and cantilever feet, is designed in such a way that a plurality of room dividers can be arranged in a staggered formation with one another while being offset by a foot width, i.e. can be tightly arrayed. In other words, the room dividers 1 can be pushed into one another. As a result, space-saving storage is made possible.

### LIST OF REFERENCE SIGNS

1, 101 room divider
2 base frame
3 crossmember
4 longitudinal member
5, 6 flap
7, 8 support arm
9 profile element
10 connection device
11, 12, 13 screen element
14 rollers
15 lighting element
16 storage compartment
17 storage tray
18 connection console
19 plug socket
20 mains socket

1. A room divider (1, 101), having:
a base frame (2) with crossmembers (3) and longitudinal members (4), wherein the longitudinal members (4) in each case have a profile element (9) provided with a longitudinal groove;
at least one flap (5, 6) which spans the base frame (2) parallel to the crossmembers (3) and which is pivotably mounted about a pivot axis;
at least one support arm (7, 8) which is connected by a first end region so as to be displaceable in the longitudinal groove of the profile element (9) of the longitudinal member and which is connected by a second end region to the flap (5, 6); and
at least one fixed screen element (11, 12, 13) which spans the base frame (2) in a region which cannot be closed by the flap (5, 6).

2. The room divider as claimed in claim 1, which also has rollers (14) for moving the room divider (1, 101).

3. The room divider as claimed in claim 1, which also has a lighting element (15), in particular a lighting element (15) which spans the base frame parallel to the crossmembers (3).

4. The room divider as claimed in claim 1, wherein the flap (6) is designed as an office work surface.

5. The room divider as claimed in claim 1, which further has a board element, in particular a magnetic board or pinboard, arranged transversely with respect to the crossmembers (3) and within the spatial volume defined by the base frame (2).

6. The room divider as claimed in claim 1, which also has a storage compartment (16) arranged transversely with respect to the crossmembers (3) and within the spatial volume defined by the base frame (2).

7. The room divider as claimed in claim 1, which also has a connection console (18) with a plurality of connection facilities for producing a connection to electrical and/or communication lines.

8. The room divider as claimed in claim 1, which also has an integrated extension cable.

9. The room divider as claimed in claim 1, wherein the room divider (101) has on the rear side at least one rear-side flap (5, 6) which is designed to be congruent to and the same size as the flap (5, 6), and at least one rear-side support arm (7, 8) which is connected by a first end region so as to be displaceable in a rear-side longitudinal groove of the longitudinal member (4) and which is connected by a second end region to the rear-side flap (5, 6).

10. The room divider as claimed in claim 9, wherein the room divider (101) has two flaps (5, 6) on the front side and, on the rear side, two rear-side flaps (5, 6) which are in each case designed to be congruent to and the same size as one of the flaps (5, 6).

11. The room divider as claimed in claim 1, wherein the room divider (1, 101) can be arranged in a staggered formation.
